(19) United States
(12) Patent Application Publication
(10) Pub. No.: US 2024/0263716 A1
(43) Pub. Date: Aug. 8, 2024

(54) ASSEMBLY AND METHOD FOR PROTECTING AN ELECTRONIC VALVE ACTUATOR

(71) Applicant: Roger Harrod, Edmond, OK (US)

(72) Inventor: Roger Harrod, Edmond, OK (US)

(21) Appl. No.: 18/435,658

(22) Filed: Feb. 7, 2024

Related U.S. Application Data
(60) Provisional application No. 63/483,673, filed on Feb. 7, 2023.

(51) Int. Cl. F16K 27/12; F16K 11/08; F16K 37/00

(52) U.S. Cl. CPC F16K 27/12; F16K 11/08; F16K 37/0075

(57) ABSTRACT

Assemblies for protecting valve actuators from water intrusion and methods of making and using the same are described. The assembly comprises a valve, a valve actuator, and a cover. The valve comprises a body and a stem. The stem is movable between a first valve position permitting passage of fluid through a flow passage in the body and a second valve position occluding passage of fluid through the flow passage. The valve actuator comprises an adapter coupled to the stem movable between a first actuator position placing the stem in the first valve position and a second actuator position placing the stem in the second valve position. The cover is disposed over the valve actuator and comprises an upper surface and a sidewall defining an inner cavity. The cover has an open bottom so as to permit air to circulate into the inner cavity and around the valve actuator.

### CROSS-REFERENCE TO RELATED APPLICATIONS

This application claims priority to the provisional patent application identified by U.S. Ser. No. 63/483,673, filed Feb. 7, 2023, the entire content of which is hereby expressly incorporated herein by reference.

### BACKGROUND ART

Ensuring healthy conditions in pools, spas, or other water features—so as to maintain visual clarity of water therein and to prevent transmission of infectious waterborne diseases—generally requires proper sanitation. Two distinct and separate methods are typically employed to effect proper sanitation: a filtration system for removing organic waste on a regular basis; and a disinfectant for killing infectious microorganisms. An exemplary filtration system may comprise: drains and skimmers for receiving water from the pool, spa, or other water features; water lines for carrying the water from the drains and skimmers, a water pump for recirculating the water, a filter through which the water is forced, and a heater for heating the water to a predetermined temperature before it is returned to the pool, spa, or other water feature.

In order to properly direct the water through the filtration system, the filtration system may be provided with a series of valves coupled to the water lines. The valves may include check valves for preventing the water from flowing in a particular direction and/or diverter valves for diverting the water from one part of the filtration system to another. For each of the valves, a valve actuator may be disposed thereon for opening, closing, or otherwise actuating the valves. The valve actuator includes an actuator shaft surrounded by a housing, and actuator circuitry for operating a motor configured to rotate the actuator shaft. To prevent water intrusion, the actuator shaft is surrounded by an O-ring. These valve actuators are configured to automatically open and permit water to circulate in the pool, spa, or water feature when the temperature drops below a predetermined temperature to prevent the water within the pool, spa or water feature from freezing. The actuator circuitry of the valve actuators may be prone to failure, however, due to water intrusion normally passing around the O-ring. When the actuator circuitry within the actuator valve fails, however, the actuator valve will not automatically open the valve, and water will not be automatically recirculated during freezing temperatures. When this occurs, damage to the pool, spa or water feature may also occur. Accordingly, a need exists for systems and methods for protecting valve actuators in filtration systems for pools, spas, or other water features from water intrusion thereby protecting the pools, spas or other water features from cold temperatures or other environmental hazards. It is to such systems and methods that the present disclosure is directed.

### SUMMARY OF THE INVENTION

The problem of protecting the actuator circuitry within valve actuators from water intrusion is addressed by the systems and methods disclosed herein. In one aspect, the present disclosure relates to an assembly, comprising: a valve comprising a valve body and a valve stem, the valve body defining a valve inlet, a valve outlet, and a valve flow passage extending between the valve inlet and the valve outlet, the valve stem being movable between a first valve position and a second valve position, the valve stem in the first valve position permitting passage of fluid through the valve flow passage, and the valve stem in the second valve position occluding passage of fluid through the valve flow passage; a valve actuator comprising an actuator housing and an actuator adapter, the actuator housing containing an actuator motor and actuator circuitry, the actuator motor being coupled to the actuator adapter, the actuator adapter being coupled to the valve stem, the actuator adapter being movable between a first actuator position and a second actuator position, the actuator adapter in the first actuator position placing the valve stem in the first valve position, the actuator adapter in the second actuator position placing the valve stem in the second valve position, and the actuator circuitry being operable to selectively engage the actuator motor to place the actuator adapter in the first actuator position or the second actuator position based at least in part on an electrical signal provided to the actuator circuitry; and an actuator cover disposed over the actuator, the actuator cover comprising a cover surface extending above the valve actuator, and a cover sidewall extending downwardly from the cover surface, the cover surface and the cover sidewall being constructed of at least one water impermeable material and collectively defining a cover inner cavity sized to accommodate movement of the valve stem and the actuator adapter, the valve actuator positioned within the cover inner cavity, the actuator cover having an open bottom so as to permit air to circulate through the open bottom into the cover inner cavity and around the valve actuator.

In another aspect, the present disclosure relates to an assembly, comprising: a valve comprising a valve body and a valve stem, the valve body defining a valve inlet, a valve outlet, and a valve flow passage extending between the valve inlet and the valve outlet, the valve stem being movable between a first valve position and a second valve position, the valve stem in the first valve position permitting passage of fluid through the valve flow passage, and the valve stem in the second valve position occluding passage of fluid through the valve flow passage; a valve actuator comprising an actuator housing and an actuator adapter, the actuator housing containing an actuator motor and actuator circuitry, the actuator motor being coupled to the actuator adapter, the actuator adapter being coupled to the valve stem, the actuator adapter being movable between a first actuator position and a second actuator position, the actuator adapter in the first actuator position placing the valve stem in the first valve position, the actuator adapter in the second actuator position placing the valve stem in the second valve position, and the actuator circuitry being operable to selectively engage the actuator motor to place the actuator adapter in the first actuator position or the second actuator position based at least in part on an electrical signal provided to the actuator circuitry; and an actuator cover disposed over the actuator, the actuator cover having a first portion and a second portion, the first portion comprising a cover surface and a cover sidewall extending from the cover surface, the second portion flaring out from the cover sidewall of the first portion such that the first portion and the second portion collectively define a cover inner cavity shaped to conform to a shape of the valve actuator, the first portion and the second portion being constructed of at least one water impermeable material.

In another aspect, the present disclosure relates to a method, comprising: passing an open bottom of an actuator cover, constructed of a water-impermeable material and an ultraviolet-resistant material, over a valve actuator connected to a valve coupled to a recreational water environment (e.g., pool or spa) or other water feature with water piping so as to cover the valve actuator and such that air can pass through the open bottom and circulate about the valve actuator; and securing the actuator cover to at least one of the valve and the water piping.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary pool filtration system constructed in accordance with the prior art;

FIG. 2 is a diagram of another exemplary pool filtration system constructed in accordance with the prior art;

FIG. 3A is a cross-sectional view of a two-way valve shown in FIG. 2, taken along the line A-A and in the direction of the arrows, shown in a first valve position to pass a fluid through the two-way valve;

FIG. 3B is another cross-sectional view of the two-way valve shown in FIG. 3A, shown in a second valve position to prevent fluid from passing through the two-way valve;

FIG. 4A is a top view of a valve actuator shown in FIG. 2;

FIG. 4B is a block diagram of the valve actuator shown in FIG. 4A;

FIG. 5A is a perspective view of an exemplary embodiment of an assembly constructed in accordance with the present disclosure;

FIG. 5B is a side view of the assembly shown in FIG. 5A;

FIG. 5C is a top view of the assembly shown in FIG. 5B;

FIG. 5D is a front view of the assembly shown in FIG. 5C;

FIG. 6A is a cross-sectional view of an “L-shape” three-way valve shown in FIG. 5D, taken along the line B-B′ and in the direction of the arrows, shown in a first valve position;

FIG. 6B is another cross-sectional view of the “L-shape” three-way valve shown in FIG. 6A, shown in a second valve position;

FIG. 6C is another cross-sectional view of the “L-shape” three-way valve shown in FIG. 6B, shown in a third valve position;

FIG. 7A is a cross-sectional view of a “T-shape” three-way valve shown in FIG. 5D, taken along the line B-B′ and in the direction of the arrows, shown in a first valve position;

FIG. 7B is another cross-sectional view of the “T-shape” three-way valve shown in FIG. 7A, shown in a second valve position;

FIG. 7C is another cross-sectional view of the “T-shape” three-way valve shown in FIG. 7B, shown in a third valve position;

FIG. 7D is another cross-sectional view of the “T-shape” three-way valve shown in FIG. 7C, shown in a fourth valve position;

FIG. 7E is another cross-sectional view of the “T-shape” three-way valve shown in FIG. 7D, shown in a fifth valve position;

FIG. 8A is a perspective view of an exemplary embodiment of a valve actuator cover constructed in accordance with the present disclosure;

FIG. 8B is a top view of the valve actuator cover shown in FIG. 8A;

FIG. 8C is a cross-sectional view of the valve actuator cover shown in FIG. 8B, taken along the line C-C′ and in the direction of the arrows;

FIG. 8D is a cross-sectional view of the valve actuator cover shown in FIG. 8C, taken along the line D-D′ and in the direction of the arrows;

FIG. 9A is a perspective view of another exemplary embodiment of a valve actuator cover constructed in accordance with the present disclosure;

FIG. 9B is a top view of the valve actuator cover shown in FIG. 9A;

FIG. 9C is a cross-sectional view of the valve actuator cover shown in FIG. 9B, taken along the line E-E′ and in the direction of the arrows;

FIG. 10 is a perspective view of another exemplary embodiment of a valve actuator cover constructed in accordance with the present disclosure; and

FIG. 11 is a perspective view of another exemplary embodiment of a valve actuator cover constructed in accordance with the present disclosure.

### DETAILED DESCRIPTION

Before explaining at least one embodiment of the inventive concept(s) in detail by way of exemplary language and results, it is to be understood that the inventive concept(s) is not limited in its application to the details of construction and the arrangement of the components set forth in the following description. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Headings are provided for convenience only and are not to be construed to limit the invention in any manner. Embodiments illustrated under any heading or in any portion of the disclosure may be combined with embodiments illustrated under the same or any other heading or other portion of the disclosure. Any combination of the elements described herein in all possible variations thereof is encompassed by the invention unless otherwise indicated herein or otherwise clearly contradicted by context.

Unless otherwise required by context, singular terms shall include pluralities and plural terms shall include the singular, with the exception that the term “plurality” as used herein, does not include the singular.

All patents or published patent applications referenced in any portion of this application are herein expressly incorporated by reference in their entirety to the same extent as if each individual patent or publication was specifically and individually indicated to be incorporated by reference.

All of the assemblies, systems, kits, and/or methods disclosed herein can be made and executed without undue experimentation in light of the present disclosure. Where a method claim does not specifically state in the claims or description that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” The term “plurality” refers to “two or more.”

The use of the term “at least one” will be understood to include one as well as any quantity more than one. In addition, the use of the term “at least one of X, Y, and Z” will be understood to include X alone, Y alone, and Z alone, as well as any combination of X, Y, and Z.

The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive.

The present disclosure is applicable to water features, which includes recreational water environments such as swimming pools, spas, and hot tubs, as well as other water features, such as fountains, waterfalls, and viewing ponds. A water feature means any outdoor or indoor structure containing water or configured to contain water, including in-ground and above-ground structures, and a recreational water environment means a water feature that is intended for swimming, socializing or recreational bathing. The present disclosure describes an exemplary pool filtration system and an exemplary pool and spa filtration system, but is equally applicable to other types of water features.

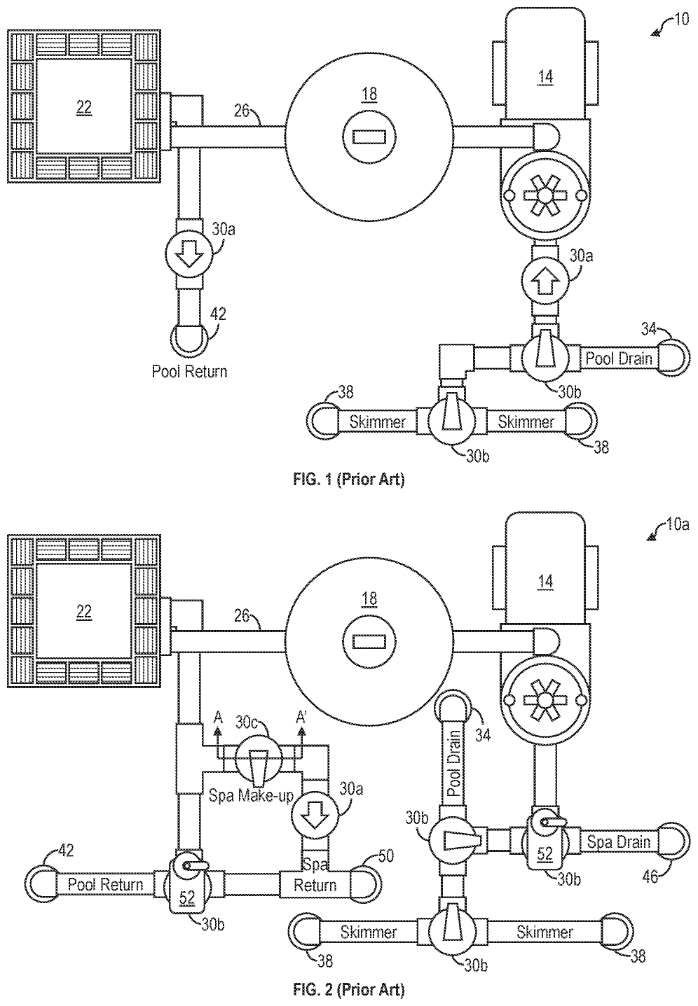

Referring now to the drawings, and in particular to FIG. 1, shown therein is a diagram of an exemplary pool filtration system 10 constructed in accordance with the prior art. The pool filtration system 10 generally comprises a pump 14, a filter 18, a heater 22, a plurality of water lines 26 (i.e., water piping) for carrying water throughout the pool filtration system 10, and a plurality of valves 30 for directing the water as it is carried by the water lines 26. For purposes of clarity, only one of the water lines 26 is labeled with a reference character. The valves 30 may 30 may include, for example, one or more check valve 30a, one or more three-way valve 30b, and/or one or more two-way valve 30c (shown in FIG. 2).

The water lines 26 may be fluidly connected to a pool, and may receive the water from a pool drain connection 34 (i.e., a fluid connection with a drain of the pool) and/or one or more pool skimmer connection 38 (i.e., a fluid connection with a skimmer of the pool). The water lines 26 may carry the water received from the pool drain connection 34 and/or the one or more pool skimmer connection 38 to the pump 14, which may circulate the water through the filter 18 and the heater 22. The water lines 26 may then deposit the water at a pool return connection 42 (i.e., a fluid connection with one or more return mechanism of the pool, which may be a pool return jet, for example) so that it may be returned to the pool. In some embodiments, at least one or more component, such as one or more valve 30, of the pool filtration system 10 is suspended above a ground surface.

Referring now to FIG. 2, shown therein is a diagram of another exemplary pool filtration system 10a constructed in accordance with the prior art. Like the pool filtration system 10 shown in FIG. 1, the pool filtration system 10a generally comprises the pump 14, the filter 18, the heater 22, the plurality of water lines 26 for carrying the water throughout the pool filtration system 10a, and a plurality of valves 30 for directing the water as it is carried by the water lines 26. For purposes of clarity, only one of the water lines 26 is labeled with a reference character. The valves 30 may include, for example, the one or more check valve 30a, the one or more three-way valve 30b, and/or the one or more two-way valve 30c.

The water lines 26 may be fluidly connected to a pool and a spa, and may receive the water from the pool drain connection 34, the one or more pool skimmer connection 38, and/or a spa drain connection 46 (i.e., a fluid connection with a drain of a spa). The water lines 26 may carry the water received from the pool drain connection 34, the one or more pool skimmer connection 38, and/or the spa drain connection 46 to the pump 14, which may circulate the water through the filter 18 and the heater 22. The water lines 26 may then selectively deposit the water at the pool return connection 42 and/or a spa return connection 50 (i.e., a fluid connection with one or more return mechanism of the spa, which may be a spa return jet, for example) so that it may be returned to the pool and/or the spa.

As described further below, at least one of the valves 30 may be provided with a valve actuator 52. For each such valve 30, the valve actuator 52 may be configured to move or actuate the valve 30 between, for example, an open position and a closed position. In some embodiments, at least one component of the pool filtration system 10a is suspended above a ground surface. For example, the at least one valve 30 may be suspended above the ground surface.

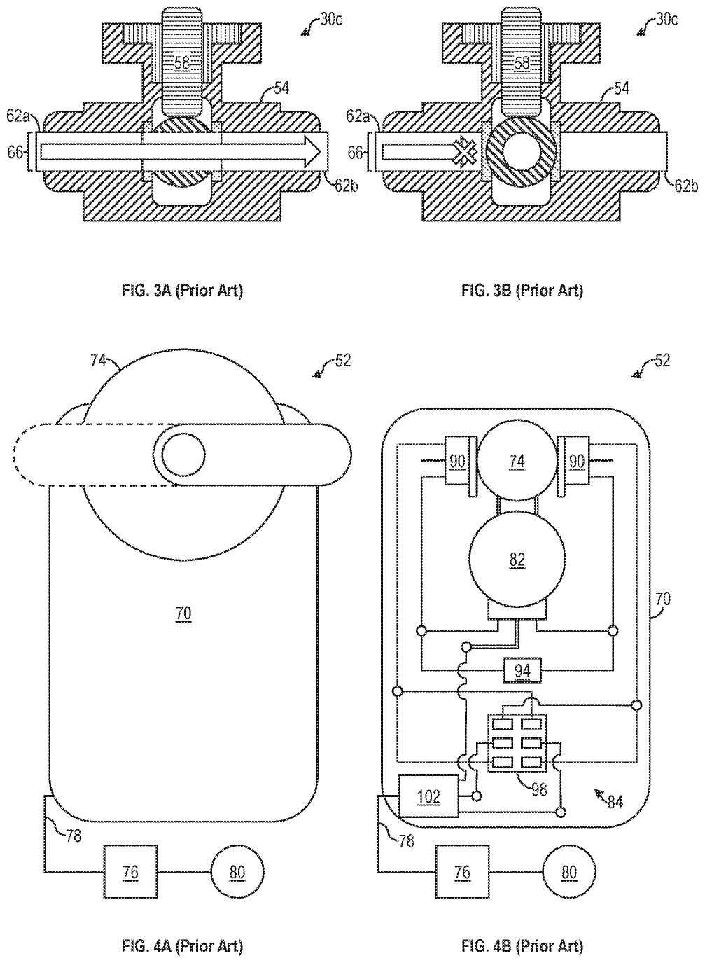

Referring now to FIGS. 3A-3B, shown therein is a cross-sectional view of the two-way valve 30c shown in FIG. 2, taken along the line A-A′ and in the direction of the arrows. The two-way valve 30c generally comprises a valve body 54 and a valve stem 58. The valve body 54 may define a plurality of valve channels 62 and a valve flow passage 66 extending between the valve channels 62. While each of the valve channels 62 may be either of a valve inlet 62a and a valve outlet 62b depending on the orientation of the two-way valve 30c, for purposes of clarity, one of the valve channels 62 is labelled as the valve inlet 62a and the other one of the valve channels 62 is labelled as the valve outlet 62b.

The valve stem 58 of the two-way valve 30c may be movable between a first valve position (shown in FIG. 3A) and a second valve position (shown in FIG. 3B). As shown in FIG. 3A, in the first valve position, the valve stem 58 of the two-way valve 30c may permit passage of fluid through the valve flow passage 66. As shown in FIG. 3B, in the second valve position, the valve stem 58 of the two-way valve 30c may occlude passage of fluid through the valve flow passage 66.

Referring now to FIG. 4A, shown therein is a top view of the valve actuator 52 shown in FIG. 2. The valve actuator may comprise an actuator housing 70 and an actuator adapter 74. When the valve actuator 52 is operatively coupled to the valve 30, the actuator adapter 74 may be coupled to the valve stem 58. The actuator adapter 74 may be movable between, for example, a first actuator position (shown with solid lines in FIG. 4A) and a second actuator position (shown with dotted lines in FIG. 4A). The actuator adapter 74 in the first actuator position may place the valve stem 58 in the first valve position, and the actuator adapter 74 in the second actuator position may place the valve stem 58 in the second valve position. As discussed further below, the actuator adapter 74 may be further movable between a third actuator position and a fourth actuator position. The actuator adapter 74 in the third actuator position may place the valve stem 58 in a third valve position. Further, the actuator adapter 74 in the fourth actuator position may place the valve stem 58 in a fourth valve position.

In some embodiments, the valve actuator 52 may be connected to a control panel 76 by an electrical cable 78. The control panel 76 may selectively provide the valve actuator 52 with electrical signals (i.e., power and/or control signals) in order to place the valve actuator 52 in the first actuator position, the second actuator position, the third actuator position, the fourth actuator position, etc. in response to a user input, for example. In some embodiments, the control panel 76 may be further connected to one or more environment sensor 80 for detecting one or more environmental condition of the environment surrounding the valve actuator 52. For example, in some embodiments, at least one of the one or more environment sensor 80 is a temperature sensor configured to determine a current temperature of the environment surrounding the valve actuator 52. Each of the one or more environment sensor may provide measurements to the control panel 76.

Referring now to FIG. 4B, shown therein is a block diagram of the valve actuator 52 shown in FIG. 4A. As shown in FIG. 4B, the actuator housing 70 may contain an actuator motor 82 and actuator circuitry 84. The actuator motor 82 may be coupled to the actuator adapter 86 such that the actuator motor 82 may move the actuator adapter 74 between the first actuator position, the second actuator position, the third actuator position, the fourth actuator position, etc. The actuator circuitry 84 may comprise, for example, a plurality of actuator limit switches 90 abutting the actuator adapter 74, an actuator capacitor 94 connected in parallel with the actuator motor 82, and an actuator toggle switch 98.

The actuator limit switches 90 may be configured to cause the actuator motor 82 to stop when the actuator adapter 74 is in the first actuator position, the second actuator position, the third actuator position, the fourth actuator position, etc.

An actuator transformer 102 may receive electrical signals via the electrical cable 78 and may provide electrical signals to the actuator motor 82 and the actuator circuitry 84. For example, the actuator transformer 102, upon receiving an electrical signal, may provide the electrical signal to the actuator circuitry 84, which may cause the actuator circuitry 84 to engage the actuator motor 82 to place the actuator adapter 74 in the first actuator position, the second actuator position, the third actuator position, the fourth actuator position, etc., based at least in part on the electrical signal.

In some embodiments, where the one or more environment sensor 80 includes at least one temperature sensor, the actuator circuitry 84 is configured to, responsive to a determination by at least one of the one or more environment sensor 80 (e.g., the at least one temperature sensor) that the current temperature is outside of a predetermined range, or below a predetermined temperature, engage the actuator motor 82 to place the valve actuator 52 in one of the first actuator position and the second actuator position. In some embodiments, the actuator circuitry 84 is configured to monitor the environment sensor 80 to determine whether the temperature is below freezing (i.e., 32 degrees Fahrenheit). In these embodiments, the actuator circuitry 84 is configured to cause the actuator motor 82 to move the actuator adapter 74, and the valve stem 58 to an open position to permit water to circulate through the valve 30, and thus the water feature, to prevent the circulating water in the water feature from freezing.

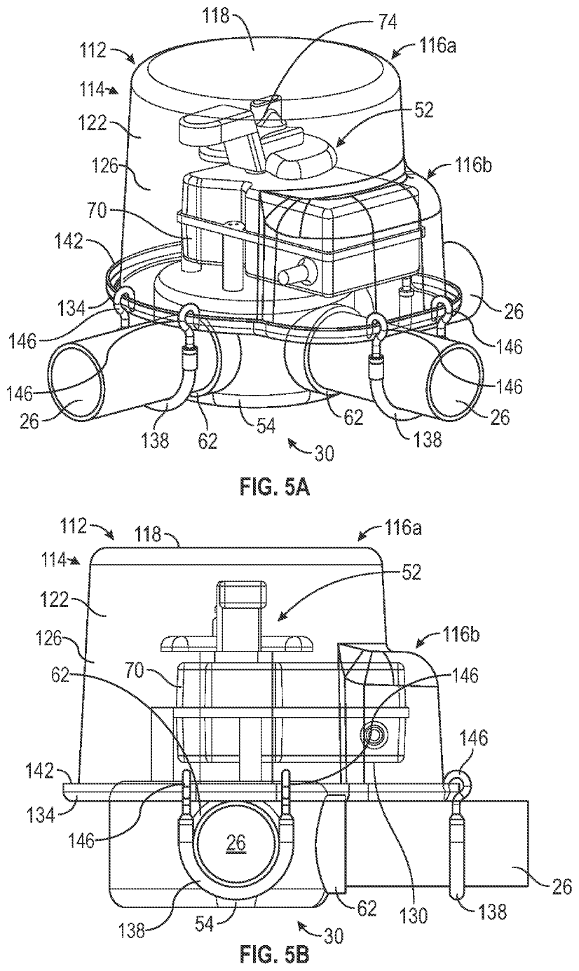

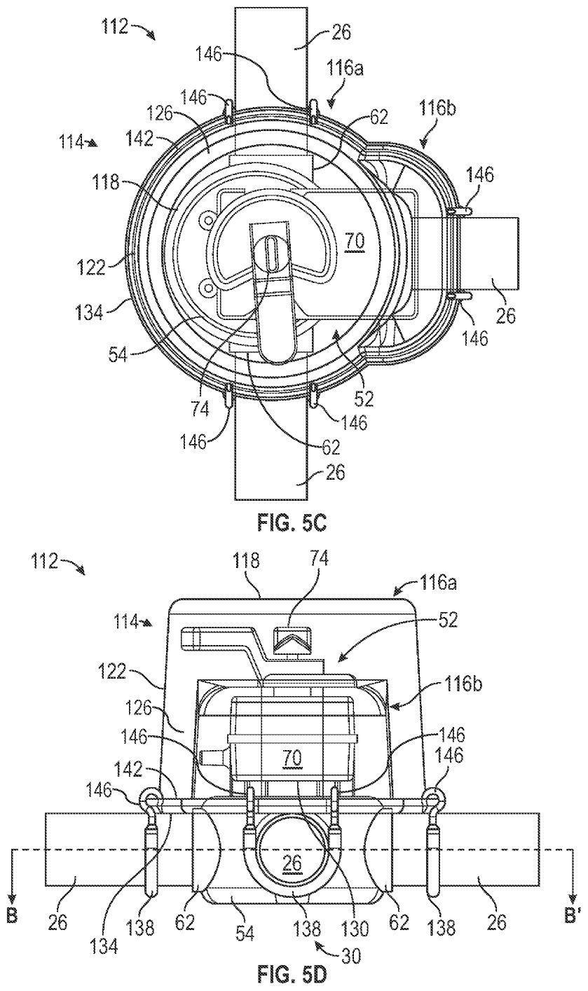

Referring now to FIGS. 5A-5D, shown therein is an exemplary embodiment of an assembly 112 constructed in accordance with the present disclosure. The assembly 112 may comprise the valve 30, the valve actuator 52, and an actuator cover 114. The actuator cover 114 is constructed of a material that is resistant to damage from sunlight and water, such as certain types of plastics and metals. The actuator cover 114 is also configured to protect the valve actuator 52 from damage due to rain, snow, sleet, hail, and other types of moisture. Suitable plastics include acrylic and high-density polyethylene. Suitable metals include stainless steel, galvanized steel, and aluminum. As shown in FIGS. 5A-5D, the actuator cover 114 may comprise a first portion 116a and a second portion 116b, the first portion 116a comprising a cover surface 118 and a cover sidewall 122 and the second portion 116b flaring out from the cover sidewall 122 of the first portion 116a such that the first portion 116a and the second portion 116b collectively define a cover inner cavity 126 shaped to conform to a portion of the shape of the valve actuator 52 while also permitting unrestricted movement of the actuator adapter 74.

The actuator housing 70 of the valve actuator 52 may have a bottom surface 130, and the actuator cover 114 may have a bottom edge 134. In some embodiments, the bottom edge 134 of the actuator cover 114 extends below the bottom surface 130 of the actuator housing 70. In some embodiments, the bottom edge 134 of the actuator cover 114 forms an open bottom so that air can circulate through the open bottom into the cover inner cavity 126 and around the valve actuator 52. In some embodiments, the assembly 112 may be further provided with one or more securing member 138 for securing the actuator cover 114 to one or more of the valve actuator 52, the valve 30, and the water lines 26.

As shown in FIGS. 5A-5D, in some embodiments, the one or more securing member 138 is one or more securing cable having ends connected to the actuator cover 114 and extending around the water line 26. In such embodiments, the bottom edge 134 of the actuator cover 114 may be provided with a rim or a lip such that the one or more securing member 138 (i.e., the one or more securing cable) may engage the bottom edge 134 (i.e., the rim or the lip) of the actuator cover 114 in order to secure the actuator cover 114 in place. However, in other embodiments, the one or more securing member 138 is one or more securing tie, for example. In such embodiments, the bottom edge 134 of the actuator cover 114 may be provided with one or more eyelet such that the one or more securing member 138 (i.e., the one or more securing tie) may engage the bottom edge 134 (i.e., the one or more eyelet) of the actuator cover 114 in order to secure the actuator cover 114 in place. In some embodiments, the assembly 112 is outside, exposed to sun and weather, and suspended above a ground surface.

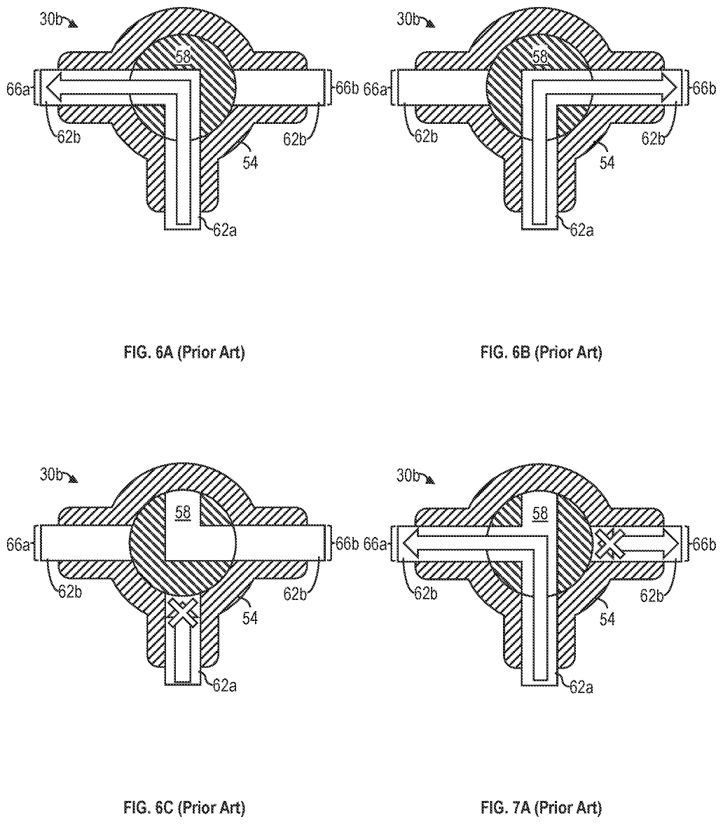

Referring now to FIGS. 6A-6C, shown therein is a cross-sectional view of the valve 30 shown in FIGS. 5A-5D, taken along the line B-B′ and in the direction of the arrows. FIGS. 5A-5D depict the valve 30 as being a three-way valve 30b. FIGS. 6A-6B depict the valve 30 as being a “L-shape” three-way valve 30b. The “L-shape” three-way valve 30b generally comprises a valve body 54 and a valve stem 58. The valve body 54 may define a plurality of valve channels 62 and a plurality of valve flow passages 66a-n extending between the valve channels 62. While each of the valve channels 62 may be either of a valve inlet 62a and a valve outlet 62b depending on the orientation of the “L-shape” three-way valve 30b, for purposes of clarity, one of the valve channels 62 is labelled as the valve inlet 62a and two of the valve channels 62 are labelled as the valve outlets 62b. Accordingly, in some embodiments, as shown in FIGS. 6A-6C, a first valve flow passage 66a may extend between the valve inlet 62a and a first valve outlet 62b, and a second valve flow passage 66b may extend between the valve inlet 62a and a second valve outlet 62b.

The valve stem 58 of the “L-shape” three-way valve 30b may be movable between a first valve position (shown in FIG. 6A), a second valve position (shown in FIG. 6B), and a third valve position (shown in FIG. 6C). As shown in FIG. 6A, in the first valve position, the valve stem 58 of the “L-shape” three-way valve 30b may permit passage of fluid through a first valve flow passage 66a and occlude passage of fluid through a second valve flow passage 66b. As shown in FIG. 6B, in the second valve position, the valve stem 58 of the “L-shape” three-way valve 30b may permit passage of fluid through the second valve flow passage 66b and occlude passage of fluid through the first valve flow passage 66a. As shown in FIG. 6C, in the third valve position, the valve stem of the “L-shape” three-way valve 30b may occlude passage of fluid through the first valve flow passage 66a and the second valve flow passage 66b.

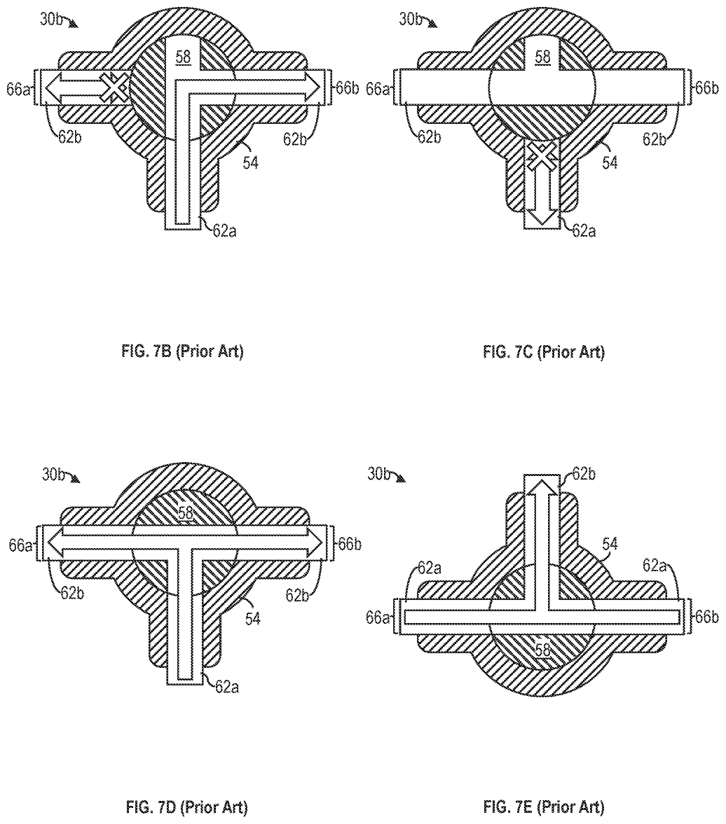

Referring now to FIGS. 7A-7E, shown therein is another cross-sectional view of the valve 30 shown in FIGS. 5A-5D, taken along the line B-B′ and in the direction of the arrows. FIGS. 7A-7E depict the valve 30 as being a “T-shape” three-way valve 30b. The “T-shape” three-way valve 30b generally comprises a valve body 54 and a valve stem 58. The valve body 54 may define a plurality of valve channels 62 and a plurality of valve flow passages 66a-n extending between the valve channels 62.

While each of the valve channels 62 may be either of a valve inlet 62a and a valve outlet 62b depending on the orientation of the “T-shape” three-way valve 30b, for purposes of clarity, one of the valve channels 62 is labelled as the valve inlet 62a and the two of the valve channels 62 are labelled as the valve outlets 62b for FIGS. 7A-7D. Accordingly, in some embodiments, as shown in FIGS. 7A-7D, a first valve flow passage 66a may extend between the valve inlet 62a and the first valve outlet 62b, and a second valve flow passage 66b may extend between the valve inlet 62a and the second valve outlet 62b.

In FIG. 7E, two of the valve channels 62 of the “T-shape” three-way valve 30b are labelled as valve inlets 62a and the other valve channel 62 is labelled as a valve outlet 62b. Accordingly, in some embodiments, as shown in FIG. 7E, a first valve flow passage 66a may extend between the first valve inlet 62a and the valve outlet 62b, and a second valve flow passage 66b may extend between the second valve inlet 62a and the valve outlet 62b.

The valve stem 58 of the “T-shape” three-way valve 30b may be movable between a first valve position (shown in FIG. 7A), a second valve position (shown in FIG. 7B), a third valve position (shown in FIG. 7C), a fourth valve position (shown in FIG. 7D), and a fifth valve position (shown in FIG. 7E). As shown in FIG. 7A, in the first valve position, the valve stem 58 of the “T-shape” three-way valve 30b may permit passage of fluid through a first valve flow passage 66a and occlude passage of fluid through a second valve flow passage 66b. As shown in FIG. 7B, in the second valve position, the valve stem 58 of the “T-shape” three-way valve 30b may permit passage of fluid through the second valve flow passage 66b and occlude passage of fluid through the first valve flow passage 66a. As shown in FIG. 7C, in the third valve position, the valve stem of the “T-shape” three-way valve 30b may occlude passage of fluid through the first valve flow passage 66a and the second valve flow passage 66b. As shown in FIGS. 7D-7E, in the fourth valve position and the fifth valve position, the valve stem of the “T-shape” three-way valve 30b may permit passage of fluid through the first valve flow passage 66a and the second valve flow passage 66b.

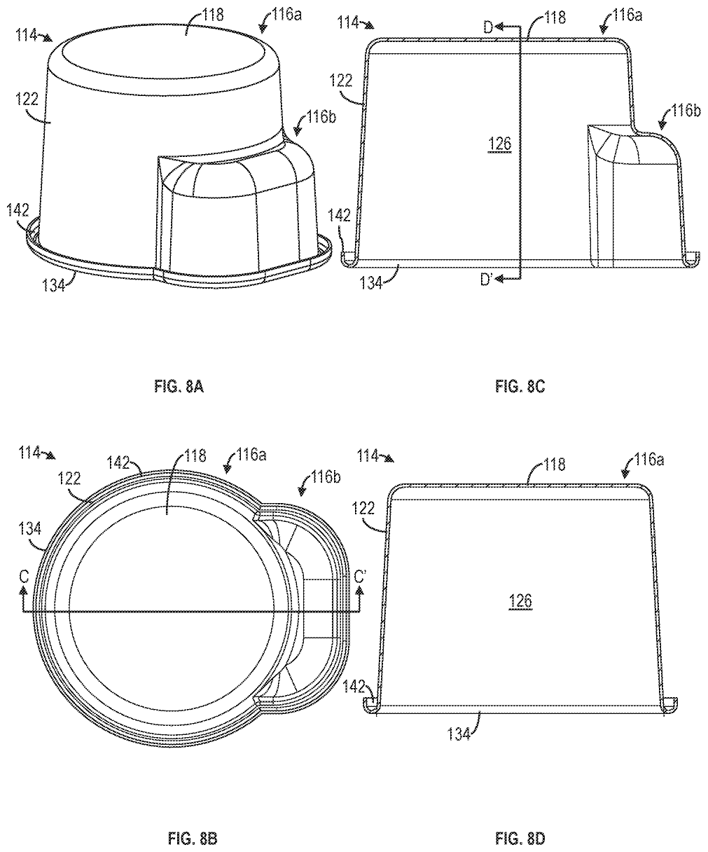

Referring now to FIGS. 8A-8D, shown therein is an exemplary embodiment of an actuator cover 114 constructed in accordance with the present disclosure. The actuator cover 114 may comprise a first portion 116a having a frustoconical shape, and a second portion 116b having a generally rectangular shape. The first portion 116a is provided with a cover surface 118 extending above the actuator adapter 74, and a cover sidewall 122 connected to the cover surface 118 and extending downwardly therefrom. The cover surface 118 and the cover sidewall 122 may be formed continuously so as to form a water impermeable barrier above and around a periphery of the actuator adapter 74 and the valve actuator 52. The second portion 116b flares out from the cover sidewall 122 of the first portion 116a so as to cover a portion of the valve actuator 52 housing the actuator circuitry 84. The first portion 116a and the second portion 116b collectively define a cover inner cavity 126 (shown in FIGS. 8C-8D) shaped to conform to an exterior shape of the valve actuator 52 (shown in FIGS. 5A-5D). Further, the actuator cover 114 may have a bottom edge 134. In some embodiments, when the actuator cover 114 is operatively coupled to the valve actuator 52, the bottom edge 134 of the actuator cover 114 extends below the bottom surface 130 of the actuator housing 70. In some embodiments, the cover sidewall 122 is configured with a sufficient height such that the bottom edge 134 rests on top of the water lines 26, and the cover surface 118 extends above the actuator adapter 74.

In some embodiments, the bottom edge 134 may be provided with a rim or a lip 142 extending upwardly such that the two hooks 146 of the one or more securing member 138 (i.e., the one or more securing cable) may engage the bottom edge 134 (i.e., the rim or the lip) in order to secure the actuator cover 114 in place. For purposes of clarity, only one of the hooks 146 is labelled with a reference character. However, in other embodiments, the bottom edge 134 may be provided with one or more eyelet such that the one or more securing member 138 (i.e., the one or more securing tie) may engage the bottom edge 134 (i.e., the one or more eyelet) in order to secure the actuator cover 114 in place.

In some embodiments, the actuator cover 114 is constructed using a water-impermeable material. In some embodiments, the actuator cover 114 is constructed using an ultraviolet-resistant material. In some embodiments, the actuator cover 114 is constructed using at least one of a plastic and a fiberglass.

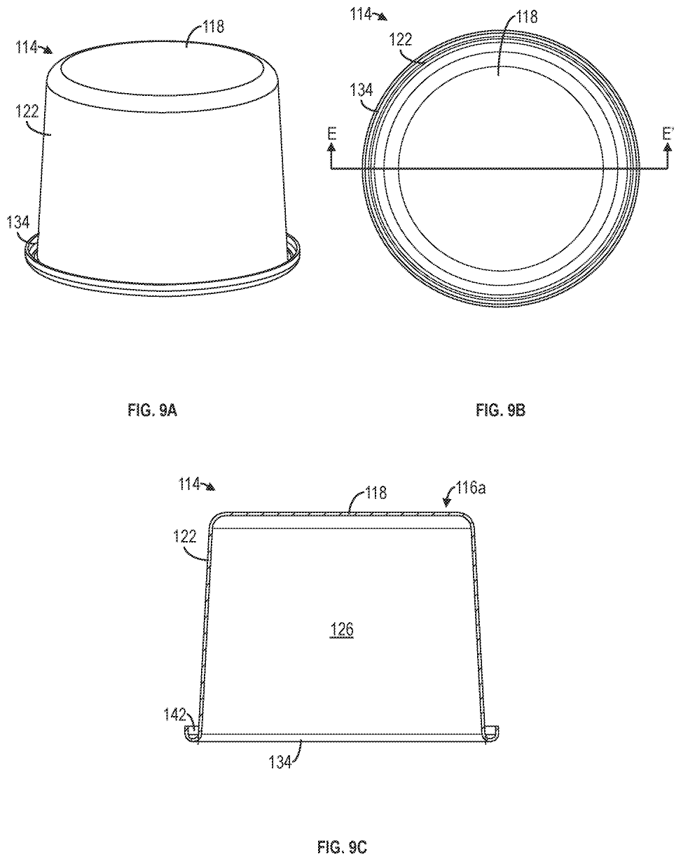

Referring now to FIGS. 9A-9C, shown therein is another exemplary embodiment of an actuator cover 114 constructed in accordance with the present disclosure. The actuator cover 114 may comprise a cover surface 118 and a cover sidewall 122 having a frusto-conical shape. The cover surface 118 and the cover sidewall 122 collectively define a cover inner cavity 126 (shown in FIG. 9C) sized to accommodate movement of the valve stem 58 of the valve 30 and the actuator adapter 74 of the valve actuator 52. Further, the actuator cover 114 may have a bottom edge 134 surrounding an open bottom permitting air to freely enter the cover inner cavity 126. In some embodiments, when the actuator cover 114 is operatively coupled to the valve actuator 52, the bottom edge 134 of the actuator cover 114 extends below the bottom surface 130 of the actuator housing 70 to protect the actuator housing 70 from sunlight and moisture.

In some embodiments, the bottom edge 134 may be provided with a rim or a lip such that the one or more securing member 138 (i.e., the one or more securing cable) may engage the bottom edge 134 (i.e., the rim or the lip) in order to secure the actuator cover 114 in place. However, in other embodiments, the bottom edge 134 may be provided with one or more eyelet such that the one or more securing member 138 (i.e., the one or more securing tie) may engage the bottom edge 134 (i.e., the one or more eyelet) in order to secure the actuator cover 114 in place.

In some embodiments, the actuator cover 114 is constructed using a water-impermeable material. In some embodiments, the actuator cover 114 is constructed using an ultraviolet-resistant material. In some embodiments, the actuator cover 114 is constructed using at least one of a plastic and a fiberglass.

In use, a user passes the open bottom of the actuator cover 114 over the valve actuator 52 connected to a valve 30 coupled to a water feature (e.g., a recreational water environment) with water lines 26 so as to cover the valve actuator 52 and such that air can pass through the open bottom and circulate about the valve actuator 52. In this position, the actuator cover 114 is secured to the valve 30 by using the one or more securing member 138. Thus, the valve actuator 52 can be covered and protected by the actuator cover 114 without removing the valve actuator 52 from the valve 30, and/or removing the valve 30 from the water lines 26. This makes the actuator cover 114 very easy to install and/or remove from the valve actuator 52.

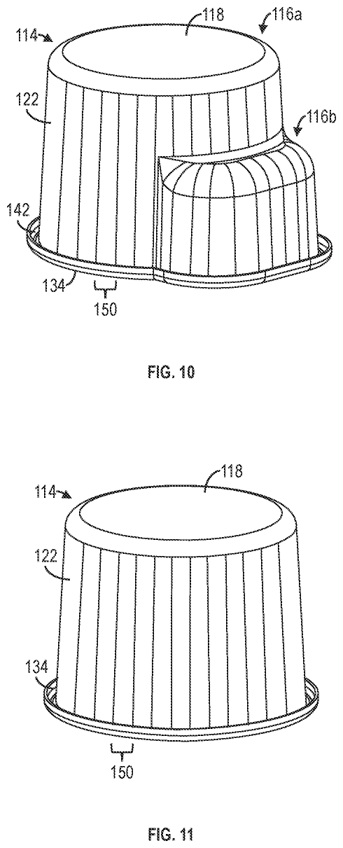

Referring now to FIG. 10, shown therein is another exemplary embodiment of an actuator cover 114 constructed in accordance with the present disclosure. The actuator cover 114 shown in FIG. 10 may be similar in form and function to the actuator cover 114 shown in FIGS. 8A-8D, except that the cover sidewall 122 of the actuator cover 114 shown in FIG. 10 may be constructed using a corrugated material having corrugations 150, i.e., alternating ridges and grooves. For purposes of clarity, only one of the corrugations 150 is labelled with a reference character in FIG. 10. In some embodiments, the corrugated material is at least one of a corrugated plastic, a corrugated fiberglass, and a corrugated sheet metal.

Referring now to FIG. 11, shown therein is another exemplary embodiment of an actuator cover 114 constructed in accordance with the present disclosure. The actuator cover 114 shown in FIG. 11 may be similar in form and function to the actuator cover 114 shown in FIGS. 9A-9C, except that the cover sidewall 122 of the actuator cover 114 shown in FIG. 11 may be constructed using a corrugated material having corrugations 150, i.e., alternating ridges and grooves, formed therein. For purposes of clarity, only one of the one or more corrugation 150 is labelled with a reference character in FIG. 11. In some embodiments, the corrugated material is at least one of a corrugated plastic, a corrugated fiberglass, and a corrugated sheet metal.

While the valve stems 58 of each of the valves 30 described herein (i.e., the check valve 30a, the three-way valve 30b, and the two-way valve 30c) are described as being movable between a number of discrete valve positions, persons having ordinary skill in the art will understand that the valve stems 58 of the valves 30 described herein are further movable between a plurality of mixed valve positions between each of the valve positions. For instance, for the two-way valve 30c, the valve stem 58 may be movable to a mixed valve position, the valve stem 58 in the mixed valve position partially occluding passage of fluid through the valve flow passage 66. Further, for the three-way valve 30b, the valve stem 58 may be movable to a mixed valve position, the valve stem 58 in the mixed valve position partially occluding passage of fluid through the first valve flow passage 66a and the second valve flow passage 66b.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. An assembly, comprising:
a valve comprising a valve body and a valve stem, the valve body defining a valve inlet, a valve outlet, and a valve flow passage extending between the valve inlet and the valve outlet, the valve stem being movable between a first valve position and a second valve position, the valve stem in the first valve position permitting passage of fluid through the valve flow passage, and the valve stem in the second valve position occluding passage of fluid through the valve flow passage;
a valve actuator comprising an actuator housing and an actuator adapter, the actuator housing containing an actuator motor and actuator circuitry, the actuator motor being coupled to the actuator adapter, the actuator adapter being coupled to the valve stem, the actuator adapter being movable between a first actuator position and a second actuator position, the actuator adapter in the first actuator position placing the valve stem in the first valve position, the actuator adapter in the second actuator position placing the valve stem in the second valve position, and the actuator circuitry being operable to selectively engage the actuator motor to place the actuator adapter in the first actuator position or the second actuator position based at least in part on an electrical signal provided to the actuator circuitry; and
an actuator cover disposed over the valve actuator, the actuator cover comprising a cover surface extending above the valve actuator, and a cover sidewall extending from the cover surface, the cover surface and the cover sidewall being constructed of at least one water impermeable material and collectively defining a cover inner cavity sized to accommodate movement of the valve stem and the actuator adapter, the valve actuator positioned within the cover inner cavity, the actuator cover having an open bottom so as to permit air to circulate through the open bottom into the cover inner cavity and around the valve actuator.

2. The assembly of claim 1, wherein the valve outlet is a first valve outlet, the valve flow passage is a first valve flow passage extending between the valve inlet and the first valve outlet, the valve body further defines a second valve outlet and a second valve flow passage extending between the valve inlet and the second valve outlet, and the valve stem is further movable between the first valve position, the second valve position, and a third valve position, the valve stem in the first valve position permitting passage of fluid through the first valve flow passage and occluding passage of fluid through the second valve flow passage, the valve stem in the second valve position occluding passage of fluid through the first valve flow passage and permitting passage of fluid through the second valve flow passage, and the valve stem in the third valve position occluding passage of fluid through the first valve flow passage and the second valve flow passage.

3. The assembly of claim 2, wherein the valve stem is further movable between the first valve position, the second valve position, the third valve position, and a fourth valve position, the valve stem in the fourth valve position permitting passage of fluid through the first valve flow passage and the second valve flow passage.

4. The assembly of claim 1, wherein at least one of the valve inlet and the valve outlet is fluidly coupled to a pool a spa, or a water feature.

5. The assembly of claim 1, wherein the actuator cover further comprises one or more securing member for securing the actuator cover to the valve actuator.

6. The assembly of claim 1, further comprising one or more temperature sensor, each of the one or more temperature sensor being configured to determine a current temperature, wherein the actuator circuitry is configured to, responsive to a determination by at least one of the one or more temperature sensor that the current temperature is outside of a predetermined range, engage the actuator motor to place the valve actuator in one of the first actuator position and the second actuator position, thereby placing the valve stem in one of the first valve position and the second valve position.

7. The assembly of claim 1, wherein the actuator housing has a bottom surface, the cover sidewall has a bottom edge, and the bottom edge of the cover sidewall extends below the bottom surface of the actuator housing.

8. The assembly of claim 1, wherein the actuator cover is constructed using a water-impermeable material.

9. The assembly of claim 1, wherein the actuator cover is constructed using an ultraviolet-resistant material.

10. The assembly of claim 1, wherein the assembly is suspended above a ground surface.

11. An assembly, comprising:
a valve comprising a valve body and a valve stem, the valve body defining a valve inlet, a valve outlet, and a valve flow passage extending between the valve inlet and the valve outlet, the valve stem being movable between a first valve position and a second valve position, the valve stem in the first valve position permitting passage of fluid through the valve flow passage, and the valve stem in the second valve position occluding passage of fluid through the valve flow passage;
a valve actuator comprising an actuator housing and an actuator adapter, the actuator housing containing an actuator motor and actuator circuitry, the actuator motor being coupled to the actuator adapter, the actuator adapter being coupled to the valve stem, the actuator adapter being movable between a first actuator position and a second actuator position, the actuator adapter in the first actuator position placing the valve stem in the first valve position, the actuator adapter in the second actuator position placing the valve stem in the second valve position, and the actuator circuitry being operable to selectively engage the actuator motor to place the actuator adapter in the first actuator position or the second actuator position based at least in part on an electrical signal provided to the actuator circuitry; and
an actuator cover disposed over the actuator, the actuator cover having a first portion and a second portion, the first portion comprising a cover surface and a cover sidewall extending from the cover surface, the second portion flaring out from the cover sidewall of the first portion such that the first portion and the second portion collectively define a cover inner cavity shaped to conform to a shape of the valve actuator, the first portion and the second portion being constructed of at least one water impermeable material.

12. The assembly of claim 11, wherein the valve outlet is a first valve outlet, the valve flow passage is a first valve flow passage extending between the valve inlet and the first valve outlet, the valve body further defines a second valve outlet and a second valve flow passage extending between the valve inlet and the second valve outlet, and the valve stem is further movable between the first valve position, the second valve position, and a third valve position, the valve stem in the first valve position permitting passage of fluid through the first valve flow passage and occluding passage of fluid through the second valve flow passage, the valve stem in the second valve position occluding passage of fluid through the first valve flow passage and permitting passage of fluid through the second valve flow passage, and the valve stem in the third valve position occluding passage of fluid through the first valve flow passage and the second valve flow passage.

13. The assembly of claim 12, wherein the valve stem is further movable between the first valve position, the second valve position, the third valve position, and a fourth valve position, the valve stem in the fourth valve position permitting passage of fluid through the first valve flow passage and the second valve flow passage.

14. The assembly of claim 11, wherein at least one of the valve inlet and the valve outlet is fluidly coupled to a recreational water environment, or a water feature.

15. The assembly of claim 11, wherein the assembly further comprises one or more securing member for securing the actuator cover to the valve actuator.

16. The assembly of claim 11, further comprising one or more temperature sensor, each of the one or more temperature sensor being configured to determine a current temperature, wherein the actuator circuitry is configured to, responsive to a determination by at least one of the one or more temperature sensor that the current temperature is outside of a predetermined range, engage the actuator motor to place the valve actuator in one of the first actuator position and the second actuator position, thereby placing the valve stem in one of the first valve position and the second valve position.

17. The assembly of claim 11, wherein the actuator housing has a bottom surface, the cover sidewall has a bottom edge, and the bottom edge of the cover sidewall extends below the bottom surface of the actuator housing.

18. The assembly of claim 11, wherein the actuator cover is constructed using a water-impermeable material.

19. The assembly of claim 11, wherein the actuator cover is constructed using an ultraviolet-resistant material.

20. A method, comprising:
passing an open bottom of an actuator cover, constructed of a water-impermeable material and an ultraviolet-resistant material, over a valve actuator connected to a valve coupled to a recreational water environment or a water feature with water piping so as to cover the valve actuator and such that air can pass through the open bottom and circulate about the valve actuator; and
securing the actuator cover to at least one of the valve and the water piping.
